(19) United States
(12) Patent Application Publication
(10) Pub. No.: US 2010/0051193 A1
(43) Pub. Date: Mar. 4, 2010

(54) PROJECTION SCREEN FABRICATION METHOD

(76) Inventors: Grant W. STEWART, Cincinnati, OH (US); James F. CISSELL, Walton, KY (US)

Correspondence Address: Hasse & Nesbitt LLC, 8837 Chapel Square Drive, Suite C, CINCINNATI, OH, 45249, US

(21) Appl. No.: 12/547,709

(22) Filed: Aug. 26, 2009

Related U.S. Application Data
(60) Provisional application No. 61/092,135, filed on Aug. 27, 2008.

(51) Int. Cl. B32B 38/00

(52) U.S. Cl. 156/275.5

(57) ABSTRACT

A method for fabricating a rear projection screen is described wherein two or more glass plates are held in a confronting generally parallel spaced relationship and a radiation curable liquid polymer resin is cast into the space between confronting surfaces of the glass plates, and the polymer resin is cured by irradiation with light of wavelength up to about 800 nanometers to form a laminated projection screen product. In one embodiment, any air remaining between the plates or in the liquid polymer resin is removed.

### CROSS-REFERENCE TO RELATED APPLICATIONS

This application claims the benefit of co-pending U.S. Provisional Application No. 61/092,135, filed Aug. 27, 2008.

### FIELD OF THE INVENTION

The present invention relates generally to projection screens, and more particularly to a method for fabricating a rear projection screen comprising two glass plates having an ultraviolet curable liquid polymer resin cast therebetween.

### BACKGROUND OF THE INVENTION

Projection screens, particularly rear transmission or back projection screens in which modulated light from a projector is illuminated on the side facing away from the viewer and that light is viewed on the side facing the viewer, are used mainly for presentations, for showing slides, films, and video, for television sets and the like.

U.S. Pat. No. 6,839,167, Eckelt, et al., describes a projection screen formed by assembling two glass plates with a sheet of white translucent polyvinyl butyral (PVB) therebetween. U.S. Pat. No. 7,253,953, Browning, describes a projection screen having two glass plates with a polymer sheet disposed therebetween comprising polyorgano silsesquioxane microspheres that enhance light diffusing properties of the screen. In Browning, the projection screen can be formed by first extruding the polymer sheet, and then sandwiching the polymer sheet between two glass plates. The entire contents of the Browning patent are incorporated by reference herein. U.S. Patent Application Publication No. US 2005/0174637 A1, Stulens, describes a rear projection screen structure having a projection side and an observation side comprising at least two transparent glass plates connected to each other by a transparent plastic film. In Stulens, the polymer sheet is provided as thin foil, and the glass plates are fixed to each other by means of the polymer foil.

### SUMMARY OF THE INVENTION

The present invention comprises a method for fabricating a rear projection screen wherein two or more glass plates are held in a confronting parallel spaced relationship and an ultraviolet (UV) curable liquid polymer resin is inserted into the space between confronting surfaces of the glass plates. In one embodiment, any air remaining between the plates is removed and the polymer resin is cured by irradiation with light radiation of wavelength up to about 800 nanometers to form a laminated projection screen product.

The invention therefore relates to a method for fabricating a projection screen, comprising the steps of:

providing at least two plates of glass;

holding said plates of glass in confronting spaced parallel relationship;

providing a source of radiation curable liquid polymer resin;

injecting said liquid polymer resin into the space between said glass plates; and

irradiating said glass plates with liquid polymer resin therebetween with light of wavelength of up to about 800 nanometers to cure said polymer resin in place between said glass plates.

The invention also relates to a method for fabricating a projection screen, comprising the steps of:

providing at least two plates of glass;

holding said plates of glass in confronting spaced parallel relationship;

providing a source of ultraviolet curable liquid polymer resin;

injecting said liquid polymer resin into the space between said glass plates;

removing trapped air from between said glass plates and said liquid polymer resin; and

irradiating said glass plates and liquid polymer resin therebetween with light of wavelength up to about 800 nanometers to cure said polymer resin in place between said glass plates.

A beneficial aspect of the invention resides in the ability to fabricate the projection screen product to substantially final specifications with little, if any, final finishing, and little, if any, waste generation. The product fabricated according to the invention typically has superior strength and shatter resistance.

Other aspects, advantages and objects of the invention will be more fully appreciated from a reading of the following detailed description of the invention.

### BRIEF DESCRIPTION OF THE DRAWINGS

FIG. 1 of the drawings illustrates one fabrication method of the invention wherein two glass plates are held in parallel spaced relationship and liquid polymer is inserted therebetween for curing by UV light.

FIG. 2 is a flow diagram illustrating steps of another fabrication method of the invention.

FIG. 3 is a view in cross section of a projection screen structure fabricated according to one method of the invention.

### DETAILED DESCRIPTION OF THE INVENTION

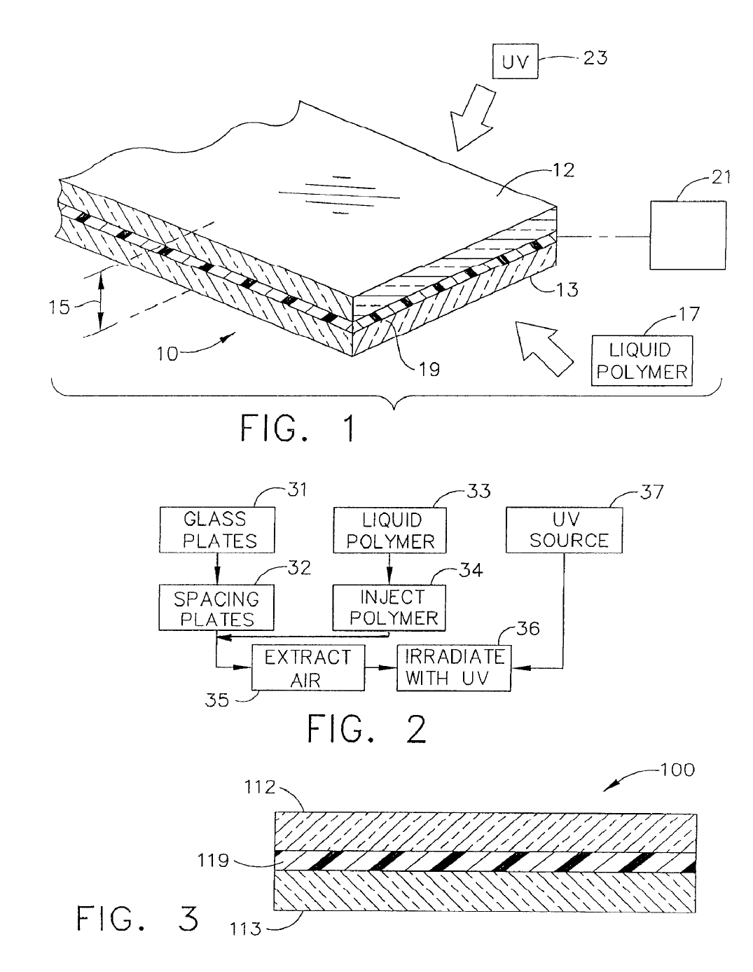

Referring now to the drawings, FIG. 1 illustrates one fabrication method of the invention. In FIG. 1, projection screen 10 comprises two glass plates 12 and 13 held in confronting parallel spaced relationship by any suitable means, illustrated schematically as spacing means 15. (As used herein, the term “parallel” means generally parallel wherein a spacing of substantially uniform thickness is defined between the plates.) The confronting surfaces of glass plates 12 and 13 can first be surface conditioned as by cleaning by any suitable means known in the art in order to promote wetting of the glass surfaces by the liquid polymer. Spacing means 15 can comprise any suitable means for holding glass plates 12 and 13 in parallel spaced relationship as would occur to the skilled artisan practicing the invention, including jigs, clamps, spacers, peripherally applied tape or other strips of material, the specific selected spacer means not considered limiting of the invention or of the appended claims.

Ultraviolet curable liquid polymer is provided from a source 17 and is injected between glass plates 12 and 13 to form the liquid polymer layer 19. The injection of the polymer can be accomplished by any suitable means, typically manually, using such as a small pump, syringe or the like. The thickness of the polymer layer 19 (thickness of the spacing between plates 12 and 13) is also not considered limiting of the invention and can be selected according to the requirements of a specific application. Layer 19 thickness for polymers useful in projection screen applications typically can range from one or two thousandths of an inch to about thirty thousandths of an inch or greater. In an aspect of the invention for fabricating a projection screen herein, layer 19 can range from about 0.015 inch to about 0.060 inch in thickness. Any residual air trapped within the liquid polymer layer 19 or between the layer 19 and the confronting surfaces of glass plates 12 and 13 can be extracted from between glass plates 12 and 13 during the insertion of liquid polymer, or following the insertion, using suitable air evacuation means 21, such as a small vacuum pump or manually using a syringe, in order to avoid trapped air bubbles in the as-cured polymer layer. Once the liquid polymer layer 19 is in place between glass plates 12 and 13, and any residual air is extracted, the assembly shown as 10 is irradiated by UV light (typically having a wavelength of less than about 400 nanometers (nm)) from a source 23. Although it is seen that UV light below 400 nm may provide suitable cure of the polymer between said plates, it is recognized that light of longer optical wavelength such as up to about 800 nm may be used for cure of the selected polymer as would occur to the skilled artisan practicing the invention.

In reference now to FIG. 2, the steps of another fabrication method of the invention are illustrated. Two or more glass plates are provided as at 31 and held in selected spaced parallel relationship as at 32. Liquid polymer as described herein is provided as at 33 and injected into the space between said glass plates as at 34. Air is extracted from between the glass plates as at 35 and the assembly of glass plates with liquid polymer therebetween is irradiated as at 36 using a source 37 of UV light. Cure time for the polymer is typically about 20 to 90 minutes depending on the length and width of the glass plates. Cure is typically performed at room temperature. Because some heat is generated in the glass plates by the irradiation with UV during cure, air cooling of the plates during cure may be desirable.

FIG. 3 is a view in cross section of a projection screen structure 100 fabricated according to a method of the invention as comprising the glass plates 112 and 113 with the UV cured polymer layer 119 therebetween. It is noted that in accordance with these teachings and the appended claims, a projection screen comprising more than two glass plates in parallel spaced relationship can be used with liquid UV curable polymer disposed between each pair of confronting plates, using the same or different polymers as the specifications or aesthetic qualities of a particular application would require.

Glass plates 12 and 13 typically employed in projection screen structures as fabricated according to the invention, can comprise a glass that is low in iron oxide for the glass plate that faces a projection device. The glass plate facing away from the projection device can comprise silicate glass with a surface roughness or coating (see the Browning patent) on its outer surface to prevent unwanted reflections. Thickness of the glass plates may be as selected by the skilled artisan. In exemplary screens fabricated according to a method of the invention, each glass plate 12 and 13 is about 0.125 inch to about 0.75 inch in thickness. Thicker glass may also be used for additional structural strength, and would have little effect on the optical performance of the screen.

In the fabrication of the structure described herein specifically for use as a rear projection screen, substantially any liquid UV curable polymer, with or without additives, can be employed as would occur to the skilled artisan guided by these teachings. Liquid polymers useful in the practice of the invention include, but are not necessarily limited to, urethane acrylate oligomers, polyester acrylate oligomers, acrylic and methacrylic acid esters and suitable well known free radical photoinitiators may be included as would occur to the skilled artisan practicing the invention. The cured polymer may be clear, translucent white or tinted as individual specifications or desired aesthetic effects require.

In one method of the invention, a urethane acrylate oligomer is used as the base resin. Its viscosity and adhesion to glass can be modified by the addition of (1) monofunctional acrylic monomers such as isobornyl acrylate, caprolactone acrylate, alkoxylated tetrahydroturfuryl acrylate, acrylic acid, triethyl hexlacrylate or other suitable acrylic monomers; and (2) di- and tri-functional acrylic monomers such as tripropylene glycol diacrylate, polyethylene glycol diacrylate, ethoxylated tripropylene glycol diacrylate, trimethylol propune triacrylate and ethoxylated tripropylene glycol triacrylate; and (3) acrylate monomers with acid residues such as acrylic acid, bishydroxyethyl methacrylate phosphate or oligomers of acrylic acid; and (4) suitable photoinitiators that will absorb UV photons and generate free radicals to cause polymerization of the mixture.

Good light diffusing characteristics of the cured polymer can be achieved through the addition of an effective amount of polyorgano silsesquioxane microspheres. The organo groups in the microspheres can be methyl, C₂-C₁₈ alkyl, hydride, phenyl, vinyl, or cyclohexyl, or mixtures thereof. Suitable microspheres are described in U.S. Pat. No. 6,773,787, Maas et al., and in U.S. Pat. No. 5,352,747, Ohtsuka et al., both incorporated herein by reference. The microspheres can be prepared by conventional methods, such as disclosed in F. Brown et al., J. Polymer Sci., Part C, No. 1, p. 83 (1983), in which one or more of the trialkoxysilanes are hydrolyzed with an acid catalyst and condensed.

In another embodiment of the invention, a commercially available UV-curable liquid polymer product, UVEKOL S (Cytec Surface Specialties Inc., Smyrna Ga.) is used in the method of the invention to form a rear projection screen with good projection characteristics.

In one embodiment, the polyorgano silsesquioxane comprises methyl, C₂-C₁₈ alkyl, hydride, phenyl, vinyl, or cyclohexyl groups, or a combination thereof. Examples include polymethyl silsesquioxane, polyphenyl silsesquioxane, polyphenyl-methyl silsesquioxane, a phenyl silsesquioxane-dimethyl siloxane copolymer in liquid form, polyphenyl-vinyl silsesquioxane, polycyclohexyl silsesquioxane, polycyclopentyl silsesquioxane, and polyhydride silsesquioxane, and combinations thereof.

In another embodiment, the polyorgano silsesquioxane is a polyalkyl siloxane powder material prepared by hydrolysis, polymerization or crosslinking of alkylsilanes or alkylsiloxanes in such a way as to give a defined particulate structure with a surface consisting largely of alkylfunctional silicone atoms. In yet another embodiment, the silicon ladder resin is a poly (methyl silsesquioxane) obtained by hydrolytic condensation in aqueous ammonia or amines of methyltri-alkoxysilanes, or their hydroxylates or condensates. The resin is spherical in shape and forms free-flowing powders, which are low in impurities such as chlorine, alkali metals, or alkaline earth metals.

The polyorgano silsesquioxane microspheres are used in amounts sufficient to provide the desired light diffusing properties. In one embodiment, from about 0.5% to about 15%, typically from about 1% to about 10%, by weight of the microspheres is included.

The polyorgano silsesquioxane microspheres typically have an average particle size of from about 0.1 to about 10 microns, more typically from about 0.5 to about 7.0 microns. A tight particle size distribution is desired for improved visual appearance and performance of the finished projection screen. In one embodiment, the microspheres are polymethyl silsesquioxane powder available from Toshiba Silicones under the trade name Tospearl 145, with a mean particle size of about 4.0 microns. In another embodiment, the microspheres are available from Toshiba Silicones under the trade name Tospearl 120, with a mean particle size of about 2.0 microns. The refractive index is about 1.42.

The polymethyl silsesquioxane microspheres herein have a low specific gravity and are easily dispersed in the liquid polymer. Moreover, they have a spherical shape and are free flowing so they do not significantly raise the viscosity of the polymer. The microspheres are efficient at diffusing light forward, but do not significantly reflect light back towards the light source. Low concentrations are often sufficient to completely diffuse the light so that one viewing the glass laminate in front of the light source does not see a concentration of light on the screen. It is important that the viewer when looking on axis to the projector light does not detect the position of the light source behind the screen. The microspheres are typically resistant to high temperatures, solvents, and plasticizers, and do not react with the chemistry of the UV cured resin to cause yellowing or other discolorations of the cured polymer layer. The microspheres are not abrasive and do not cause excessive wear to processing equipment as do some other pigments. Other suitable materials for causing light diffusion in the UV cured resin include, glass microspheres, alumina, pearlescent mica pigments and white mineral oxides in particle size and weight percent as suggested above.

By way of example, representative ultraviolet light stabilizers include various substituted resorcinols, salicylates, benzotriazole, benzophenones, and the like. Suitable lubricants and mold release agents include stearic acid, stearyl alcohol, and stearamides. Exemplary flame-retardants include organic halogenated compounds, including decabromodiphenyl ether and the like, as well as inorganic compounds. Suitable coloring agents, dyes and pigments include cadmium sulfide, cadmium selenide, titanium dioxide, phthalocyanines, ultramarine blue, nigrosine, carbon black and the like. Representative oxidative and thermal stabilizers include the Group I metal halides, such as sodium halides, potassium halides, and lithium halides, as well as cuprous halides, and also chlorides, bromides, and iodides, hindered phenols, hydroquinones, and aromatic amines, as well as substituted members of those above mentioned groups, and combinations thereof. Exemplary plasticizers include lactams such as caprolactam and lauryl lactam, sulfonamides such as o,p-toluenesulfonamide and N-ethyl, N-butyl benylnesulfonamide, and combinations of the above. Other plasticizers commonly employed are esters of a polybasic acid or a polyhydric alcohol. Suitable plasticizers include, for example, triethylene glycol di-(2-ethylbutyrate), triethylene glycol di-(2-ethylhexanoate), triethylene glycol diheptanoate, tetraethylene glycol diheptanoate, dihexyl adipate, dioctyl adipate, hexyl cyclohexyladipate, mixtures of heptyl and nonyl adipates, diisononyl adipate, heptylnonyl adipate, dibutyl sebacate, polymeric plasticizers such as the oil-modified sebacic alkyds, and mixtures of phosphates and adipates such as disclosed in U.S. Pat. No. 3,841,890, and adipates such as disclosed in U.S. Pat. No. 4,144,217. Also commonly employed plasticizers are mixed adipates made from C₄ to C₉ alkyl alcohols and cyclo C₄ to C₁₀ alcohols, as disclosed in U.S. Pat. No. 5,013,779, e.g., C₆ to C₈ adipate esters, such as dihexyl adipate.

In one embodiment, the UV curable resin comprises, by weight, from about 10% to about 25% of a urethane acrylate, about 50% to about 75% of suitable acrylate monomers, about 2% to about 5% of a suitable photoinitiator and about 0.5% to about 15% polysiloxane microspheres.

The invention therefore provides a novel method for fabricating a rear projection screen. It is understood that modifications, adaptations and alternatives to the invention as described may be made as might occur to one with skill in the field of the invention within the scope of the appended claims. All embodiments contemplated hereunder have therefore not been shown in complete detail. Other embodiments may be developed without departing from the spirit of the invention or from the scope of the appended claims.

What is claimed is:

1. A method for fabricating a projection screen, comprising the steps of:
(a) providing at least two plates of glass;
(b) holding said plates of glass in confronting spaced parallel relationship;
(c) providing a source of radiation curable liquid polymer resin;
(d) injecting said liquid polymer resin into the space between said glass plates; and
(e) irradiating said glass plates and liquid polymer resin therebetween with light of wavelength up to about 800 nanometers to cure said polymer resin in place between said glass plates.

2. The method of claim 1 wherein said liquid polymer resin comprises a mixture of materials selected from the group consisting of urethane acrylates, polyester acrylates, epoxy acrylates, mono-, di-, and tri-functional acrylic monomers.

3. The method of claim 1 wherein said liquid polymer resin has dispersed therein light diffusing particles comprising polymethyl silsesquioxane, glass microspheres, alumina particles, pearlescent mica pigments or white mineral oxides.

4. The method of claim 3 wherein said light diffusing particles have a mean particle size of equal to or less than about 4 microns.

5. The method of claim 4 wherein said liquid polymer resin comprises from about 1% to about 10% by weight of said light diffusing particles liquid polymer resin.

6. The method of claim 1 further comprising, following the step of injecting said liquid polymer resin into the space between said glass plates, the step of removing trapped air from between said glass plates.

7. The method of claim 1 where said glass plates have thickness of about 0.125 inch to about 0.75 inch.

8. The method of claim 1 wherein said glass plates are spaced apart about 0.015 to about 0.060 inch.

9. The method of claim 1 wherein one of said glass plates has low iron oxide content.

10. The method of claim 1 wherein at least one of said glass plates comprises silicate glass.

11. A method for fabricating a projection screen, comprising the steps of:
(a) providing at least two plates of glass;
(b) holding said plates of glass in confronting spaced parallel relationship;
(c) providing a source of radiation curable liquid polymer resin;
(d) injecting said liquid polymer resin into the space between said glass plates;
(e) removing trapped air from between said glass plates; and
(f) irradiating said glass plates and liquid polymer resin therebetween with light of wavelength up to about 800 nanometers to cure said polymer resin in place between said glass plates.

12. The method of claim 11 wherein said liquid polymer resin comprises a mixture of materials selected from the group consisting of urethane acrylates, polyester acrylates, epoxy acrylates, mono-, di-, and tri-functional acrylic monomers, and a photoinitiator.

13. The method of claim 11 wherein said liquid polymer resin has dispersed therein light diffusing particles comprising polymethyl silsesquioxane, glass microspheres, alumina particles, pearlescent mica pigments or white mineral oxides.

14. The method of claim 13 wherein said light diffusing particles have a mean particle size of equal to or less than about 4 microns.

15. The method of claim 14 wherein said liquid polymer resin comprises from about 1% to about 10% by weight of said light diffusing particles.

16. The method of claim 11 where said glass plates have thickness of about 0.125 inch to about 0.75 inch.

17. The method of claim 11 wherein said glass plates are spaced apart about 0.015 to about 0.060 inch.

18. The method of claim 11 wherein one of said glass plates has low iron oxide content.

19. The method of claim 11 wherein at least one of said glass plates comprises silicate glass.

20. A method for fabricating a projection screen, comprising the steps of:
(a) providing at least two plates of glass;
(b) holding said plates of glass in confronting spaced parallel relationship;
(c) providing a source of radiation curable liquid polymer resin comprising a material selected from the group consisting of urethane acrylates, polyester acrylates, epoxy acrylates, mono-, di-, and tri-functional acrylic monomers, said resin having dispersed therein from about 1% to about 10% by weight of said resin of light diffusing particles having a mean particle size of equal to or less than about 4 microns comprising polymethyl silsesquioxane, glass microspheres, alumina particles, pearlescent mica pigments or white mineral oxides;
(d) injecting said resin into the space between said glass plates;
(e) removing trapped air from between said glass plates and said resin; and
(f) irradiating said glass plates and liquid polymer resin therebetween with light of a wavelength up to about 800 nanometers to cure said polymer resin in place between said glass plates.
